(19) United States
(12) Patent Application Publication
(10) Pub. No.: US 2011/0314195 A1
(43) Pub. Date: Dec. 22, 2011

(54) MAGNETIC RESONANCE APPARATUS WITH A DATA TRANSFER UNIT TO TRANSFER DATA BETWEEN A MEASUREMENT SYSTEM AND AN EVALUATION SYSTEM, AND A TRANSFER METHOD THEREFOR

(76) Inventor: Gerald Mattauch, Dormitz (DE)

(21) Appl. No.: 13/162,885

(22) Filed: Jun. 17, 2011

(30) Foreign Application Priority Data
Jun. 17, 2010 (DE) 10 2010 030 236.8

(51) Int. Cl. G06F 13/42

(52) U.S. Cl. 710/105

(57) ABSTRACT

A magnetic resonance apparatus has at least one basic magnet that generates a basic magnetic field, a measurement system that is arranged within a region permeated by the basic magnetic field, an evaluation system that is arranged outside of the region permeated by the basic magnetic field, and a data transfer unit to transfer data between the measurement system and the evaluation system. The data transfer unit has at least one USB standard unit along a transmission path of the data transfer between the measurement system and the evaluation system.

### BACKGROUND OF THE INVENTION

1. Field of the Invention

The present invention concerns a magnetic resonance apparatus of the type having at least one basic magnet that generates a basic magnetic field, a measurement system that is arranged within a region permeated by the basic magnetic field, an evaluation system that is arranged outside of the region permeated by the basic magnetic field, and a data transfer unit to transfer data between the measurement system and the evaluation system.

2. Description of the Prior Art

For a measurement excitation and a measurement data acquisition, a conventional magnetic resonance apparatus has a measurement system with subsystems, with the measurement system arranged within a region permeated by a basic magnetic field. In addition, the conventional magnetic resonance apparatus has an evaluation system with subsystems for a data evaluation and a data reconstruction, the evaluation system being arranged outside of the region permeated by the basic magnetic field. Measurement data acquired by the measurement system must be transmitted therefrom to the evaluation system. Additionally, signals can be transmitted from the evaluation system to the measurement system to control a measurement excitation.

The strong basic magnetic field that is present for a measurement excitation and data acquisition must be taken into account for the data transfer between the measurement system and the evaluation system. Additional requirements for the data transfer are a high data rate and low noise for measurement data and/or control data, as well as a high sensitivity of a magnetic resonance measurement to possible interference that (for example) can be caused by an electrical data transfer.

Magnetic resonance apparatuses are known in which proprietary transfer components that can include both transfer elements and transfer software—for example in the form of transfer programs—are used. The evaluation system includes receiver cards in (for example) a reconstruction unit to provide acquired measurement data for an image reconstruction. The measurement system likewise includes receiver cards for an activation unit.

However, such proprietary transfer components have the disadvantage that they must be developed in a complicated manner for this application field, which results in a high time expenditure and high economic costs. In addition, the proprietary transfer components contribute to a high overall complexity of the data transfer, and therefore of the magnetic resonance apparatus.

### SUMMARY OF THE INVENTION

An object of the present invention is to provide a magnetic resonance apparatus with a data transfer unit that enables a cost-effective data transfer and additionally reduces the complexity of the data transfer.

The invention is based on a magnetic resonance apparatus with at least one basic magnet that generates a basic magnetic field, a measurement system that is arranged within a region permeated by the basic magnetic field, an evaluation system that is arranged outside of the region permeated by the basic magnetic field, and a data transfer unit to transfer data between the measurement system and the evaluation system.

In accordance with the invention, the data transfer unit has at least one USB standard unit along a transfer route (path) of the data transfer between the measurement system and the evaluation system. A USB standard unit in this context means a serial bus system that is standard for data transfer in which individual bits of a data packet to be transferred can be transferred serially. The data transfer takes place symmetrically via two twisted conductors, wherein one of the two conductors transfers a data signal and the other of the two conductors transfers a signal inverted relative to the data signal. A fast data transfer that prevents an unwanted delay in the transfer of measurement data and/or control data can be achieved according to the invention. The control data can be generated by a separate control unit and can be transferred to the measurement system via the evaluation system. For this purpose, the evaluation system has a control unit that generates the data to be transferred to the measurement system. Furthermore, a particularly cost-effective transfer standard for the data transfer can be provided, and thus complex and expensive proprietary transfer components (and possibly associated driver software for the proprietary transfer components) can be foregone. In addition, a simplified design of the data transfer unit can be achieved in that a complexity of the data transfer unit can be reduced by means of the USB standard units. The USB standard unit can be formed by a USB 3.0 standard unit or higher.

In a further embodiment of the invention, the data transfer unit has at least two USB standard units, so the bandwidth available in the transfer unit and/or in the magnetic resonance apparatus can be utilized for the data transfer. The incoming data to be transferred are distributed to an available number of USB standard units. The at least two USB standard units are arranged parallel to one another for a data transfer.

Furthermore, that the USB standard unit can be at least partially arranged outside of the region permeated by the basic magnetic field, such that interference with the data transfer and/or with a measurement experience (for example interference that can arise due to an electrical data transfer) can be prevented.

The data transfer unit preferably has at least one transducer unit for an at least partial conversion of an electrical USB data transfer protocol into an optical data transfer protocol and/or conversion of an optical data transfer protocol into an electrical USB data transfer protocol. Data thus can be exchanged without disruption between the USB standard unit and the measurement unit within the region permeated by the basic magnetic field. The data transfer unit can have optical cables and/or fibers (for example glass fiber cables or the like) for data transfer within the region permeated by the basic magnetic field. A data transfer protocol in this context means an exact agreement procedure according to which data can be exchanged between computers and/or processors, for example, wherein the computers and/or processors are connected with one another by a network, in particular a data network.

In order to prevent interference with the data transfer and/or a magnetic field, and of a magnetic resonance measurement that is associated with the data transfer, the transducer unit is arranged outside of the region permeated by the basic magnetic field.

In a further embodiment of the invention, that the data transfer unit has at least one shielding unit that shields electromagnetic radiation, the shielding unit being within the region permeated by the basic magnetic field, and the transducer unit is at least partially arranged within the shielding unit shielding the electromagnetic radiation. A particularly cost-effective additional processing of data within the measurement unit can be achieved, for example with the use of standard hardware components (in particular USB standard components). In addition, the optical transfer protocol can again be converted into an electrical USB transfer protocol so that a conversion of the optical transfer protocol into optical data can advantageously be omitted.

A particularly compact and in particularly cost-effective evaluation system can be achieved when the evaluation system has at least one mainboard to accommodate a processor unit and the USB standard unit is at least partially directly coupled to the mainboard.

The evaluation system can additionally have at least one PCI unit, and the USB standard unit can be at least partially coupled with the PCI unit. A PCI unit in this context means a bus that is standard to connect peripheral devices (in particular a USB standard unit) with a processor. For example, the PCI unit can be formed by a PCI host adapter card and/or be additional elements and/or units appearing to those skilled in the art to be reasonable. The evaluation system can additionally have multiple PCI units so that here multiple USB standard units can couple with the data transfer unit for a data transfer to the evaluation system.

Furthermore, the invention encompasses a transfer method for a magnetic resonance apparatus, wherein a data transfer takes place between a measurement system arranged within a basic magnetic field and an evaluation system arranged outside of the basic magnetic field.

In accordance with the invention, the data transfer takes place at least partially by means of at least one USB standard unit. A particularly cost-effective and fast data transfer that prevents an unwanted delay in a transfer of measurement data and/or control data can be achieved. The USB standard unit is formed by a USB 3.0 standard unit or higher.

The invention also encompasses a transfer method with a transducer step in which an electrical USB data transfer protocol is converted into an optical data transfer protocol and/or an optical data transfer protocol is converted into an electrical USB data transfer protocol. Data can thus be exchanged without interference between the USB standard unit and the measurement unit within the region permeated by the basic magnetic field.

### BRIEF DESCRIPTION OF THE DRAWINGS

FIG. 1 shows a magnetic resonance apparatus according to the invention in a schematic representation.

FIG. 2 illustrates a data transfer method according to the invention.

FIG. 3 shows a magnetic resonance apparatus designed as an alternative to FIG. 1, in a schematic representation.

### DESCRIPTION OF THE PREFERRED EMBODIMENTS

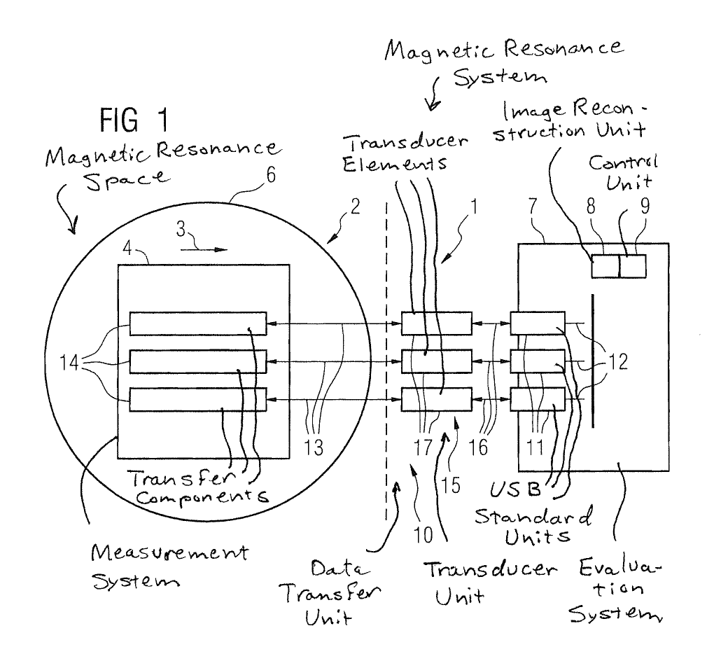

A magnetic resonance apparatus 1 according to the invention is schematically shown in FIG. 1. The magnetic resonance apparatus 1 has a basic magnet that, in the operation of the magnetic resonance apparatus 1, generates a constant, strong basic magnetic field 3 for a polarization of protons in an examination subject, in particular in a patient. In addition to the basic magnet, the magnetic resonance apparatus 1 has a gradient coil (known and therefore not shown in detail) that generates a linear gradient field and a radio-frequency coil (known and therefore not shown in detail) that radiates pulses that deflect the magnetization of nuclear spins in an examination subject and to detect the resulting magnetic resonance signal.

Furthermore, the magnetic resonance system 1 has a measurement system 4 that has multiple subsystems for a measurement excitation and a measurement data acquisition. The measurement system 4 with its subsystems is arranged within a region 6 permeated by the basic magnetic field 3 during a magnetic resonance measurement. The subsystems can be formed by the gradient coil, the radio-frequency coil, etc. The measurement system, together with the basic magnet, the gradient coils and the radio-frequency coils, is arranged within a magnetic radiation-shielded magnetic resonance space 2 of the magnetic resonance apparatus 1.

In addition to the measurement system 4, the magnetic resonance apparatus 1 has an evaluation system 7 that has multiple subsystems 8 to reconstruct acquired data and a controller of (for example) individual subsystems of the measurement system 4. The evaluation system 7 is arranged outside of the region permeated by the basic magnetic field 3 and outside of the magnetic resonance space 2. The subsystems of the evaluation unit 7 can be formed by a central control unit 9 of the magnetic resonance apparatus 1, for example, which central control unit 9 controls the individual components of the magnetic resonance apparatus 1.

For a data transfer between the measurement system 4 and the evaluation system 7, the magnetic resonance apparatus 1 has a data transfer unit 10. For this the data transfer unit 10 comprises multiple USB standard units 11 along a transmission path of the data transfer between the measurement system 4 and the evaluation system 7. The USB standard units 11 are respectively formed by a USB 3.0 standard unit or higher, such that a high data transfer rate can be achieved between the measurement system 4 and the evaluation system 7 and an unwanted delay is additionally prevented during a data transfer. Three USB 3.0 standard units that are arranged parallel to one another are shown as examples in FIG. 1. However, in an alternative embodiment of the data transfer unit 10 a number of USB standard units 11 can be fashioned differently with regard to a number in the exemplary embodiment shown here.

By means of the data transfer unit 10, measurement data acquired by the measurement system are transferred to the evaluation system 7, and control data are transferred from the evaluation system 7 to the measurement system 4 for an activation of the individual subsystems of the measurement system 4. For this purpose, control data are generated by the control unit 9 and transferred to the measurement system 4. In principle the magnetic resonance apparatus 1 can also have a control unit that is fashioned separate from the evaluation system 7, wherein the data transfer can take place to the measurement system 4 via the evaluation system 7, or to the measurement system 4 independently of the evaluation system 7.

The USB 3.0 standard units are arranged outside of the region 6 permeated by the basic magnetic field 3 in order to prevent an interference with a magnetic resonance measurement. The USB 3.0 standard units connect to a respective PCI unit 12 of the evaluation system 7. For example, the PCI units 12 are respectively formed by a PCIe 2.0 host adapter card and/or additional units and/or elements appearing to be reasonable to those skilled in the art.

Within the region 6 permeated by the basic magnetic field 3, an optical data transfer takes place by means of optical fibers and/or optical cables 13 of the data transfer unit 10 in order to suppress an interference with the magnetic resonance measurement due to an electrical data transfer. For example, the optical fibers and/or optical cables 13 are formed by a glass fiber cable and/or by polymer optical fibers etc. Within the measurement system the data transfer unit has multiple proprietary data transfer components 14 that, for example, are formed by proprietary receiver cards and/or additional proprietary data transfer components 14 that appear to be reasonable to the man skilled in the art. By means of these proprietary data transfer components 14, data and/or signals that are transferred to the measurement system 4 by means of the optical fibers and/or optical cables 13 are received and relayed to the corresponding subsystems of the measurement system 4. Measurement data received by means of the proprietary data transfer components 14 are likewise transferred in the direction of the evaluation system 7 by means of the optical fibers and/or the optical cable 13.

The data exchange between the measurement system 4 and the evaluation system 7 takes place via a transducer unit 15 of the data transfer unit 10, wherein the transducer unit 15 is arranged outside of the region 6 permeated by the basic magnetic field 3. The transducer unit 15 converts an electrical USB data transfer protocol into an optical data transfer protocol and/or an optical data transfer protocol into an electrical USB data transfer protocol. The transducer unit 15 is connected with the individual USB 3.0 standard units by means of a USB cable 16 of the data transfer unit 10 and is connected with the individual proprietary transfer components 14 by means of the optical fibers and/or optical cables 13. The USB cable 16 is formed by a USB 3.0 cable. The transducer unit 15 has multiple transducer elements 17, wherein the number of transducer elements is matched to the number of USB 3.0 standard units and/or a number of proprietary transfer components 14. Due to the three USB 3.0 standard units 11, the three transducer elements 17 and the three proprietary transfer components 14, multiple transfer channels are thus provided for the data transfer, wherein the incoming data to be transferred are divided among the available transfer channels.

In an alternative embodiment of the invention, the data transfer unit can be provided with only one USB 3.0 standard unit 11, only one transducer element 17 and only one proprietary transfer component 14.

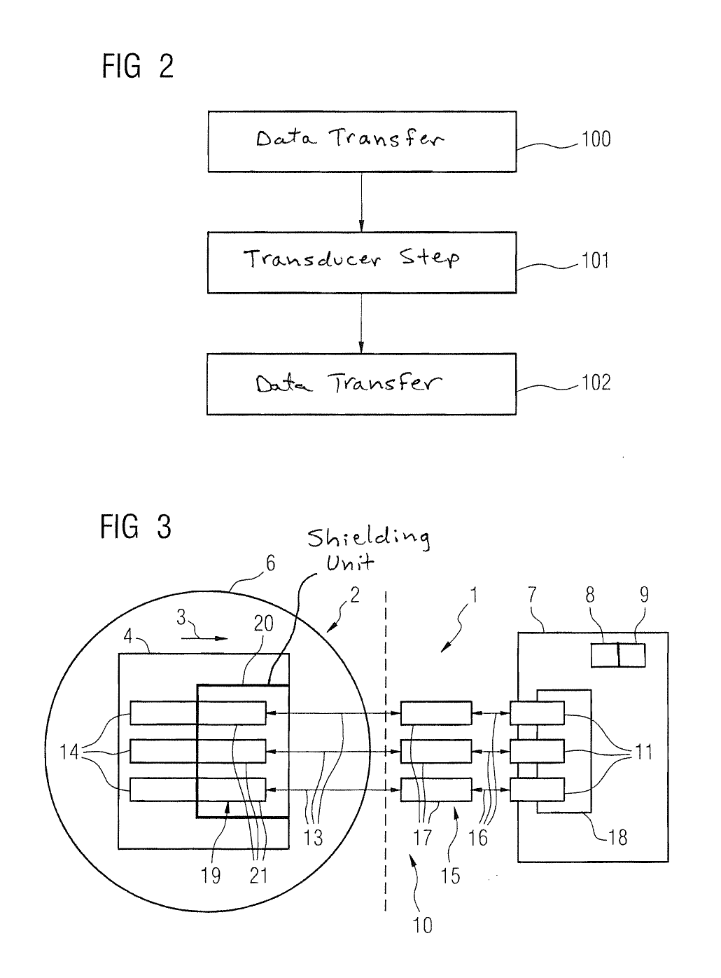

In the operation of the magnetic resonance apparatus 1, a continuous data exchange takes place between the evaluation system 7 and the measurement system 4, for example in order to transfer control data from the evaluation system 7 to the measurement system 4 and/or in order to transfer measurement data from the measurement system 4 to the evaluation system 7 for a subsequent image reconstruction. A data transfer 100 takes place within the data transfer unit 10 according to a data transfer method (FIG. 2). Initially a data transfer 100 takes place from the measurement system to the transducer unit 15 via the proprietary transfer component 14 and the optical fibers and/or optical cable 13 or, respectively, from the evaluation system 7 to the transducer unit 15 via the PCI units 12, the USB 3.0 standard units 11 and the USB 3.0 cable.

A transducer step 101 in which the electrical USB data transfer protocol with the data to be transferred is converted and/or translated into an optical data transfer protocol, and/or in which the optical data transfer protocol with the data to be transferred is converted and/or translated into an electrical USB data transfer protocol, subsequently takes place at the transducer unit 15.

A further data transfer 102 subsequently takes place. The electrical USB data transfer protocol is transferred by means of the USB 3.0 cables to the USB 3.0 standard units, and the optical data transfer protocol is transferred by means of the optical fibers and/or the optical cables 13 to the proprietary transfer components 14. The data conducted to the measurement system 4 and/or to the evaluation system 7 are subsequently additionally processed within the measurement system 4 and/or the evaluation system 7.

An alternative exemplary embodiment of the magnetic resonance apparatus 1 is shown in FIG. 3. Essentially unchanged modules, features and functions are basically numbered with the same reference characters. The following description is essentially limited to the differences relative to the exemplary embodiment in FIGS. 1 and 2, wherein the description of the exemplary embodiment in FIGS. 1 and 2 is referenced with regard to unchanged modules, features and functions.

In contrast to the exemplary embodiment from FIG. 1, the magnetic resonance apparatus 1 from FIG. 3 has an evaluation unit 7 into which USB standard units 11 (in particular USB 3.0 standard units) are integrated. USB interfaces and/or USB ports (in particular USB 3.0 interfaces and/or USB 3.0 ports) can already be integrated into a mainboard 18 of the evaluation unit 7, for example, such that the USB standard units 11 connect directly to the mainboard 18. In addition to the USB interfaces and/or USB ports, the mainboard 18 comprises additional units, in particular a processor unit (not shown in detail).

An additional difference relative to the exemplary embodiment in FIG. 1 is that the data transfer unit 10 has an additional transducer unit 19. This additional transducer unit 19 is arranged within a measurement system 4 of the magnetic resonance apparatus 1, wherein for this purpose the measurement system 4 has a shielding unit 20 that shields against an electromagnetic radiation. The additional transducer unit is arranged within the shielding unit 20 shielding against the electromagnetic radiation, such that an interference with a magnetic resonance measurement can advantageously be prevented. In this exemplary embodiment the additional transducer unit 19 has three transducer elements 21, wherein a number of transducer elements 21 can vary in an alternative embodiment of the additional transducer unit 19.

The additional transducer unit 19 converts and/or transforms an optical data transfer protocol arriving from the first transducer unit 15 back into an electrical USB data transfer protocol. The measurement system 4 advantageously has additional units (not shown in detail) to additionally process and/or relay the electrical USB data transfer protocol, wherein the additional units are arranged within the shielding unit 20 shielding the electromagnetic radiation. In addition, an electrical USB data transfer protocol is converted by the additional transducer unit 19 into an optical data transfer protocol before relaying in a direction of the first transducer unit 15. Cost-effective USB units for an additional processing of the control signals can thus also be used within the measurement system 4.

Although modifications and changes may be suggested by those skilled in the art, it is the intention of the inventor to embody within the patent warranted hereon all changes and modifications as reasonably and properly come within the scope of his contribution to the art.

I claim as my invention:

1. A magnetic resonance apparatus, comprising:
a basic field magnet that generates a basic magnetic field that permeates a region;
a measurement system located within said region permeated by said basic magnetic field, said measurement system being configured to excite nuclear spins in an examination subject located in the basic magnetic field, and to detect resulting magnetic resonance signals from the subject;
an evaluation system located outside of said region permeated by said magnetic field, said evaluation system being configured to evaluate said magnetic resonance signals detected by said measurement system;
a data transfer unit that transfers data, including data representing said magnetic resonance signals, between said measurement system and said evaluation system along a transmission path between said measurement system and said evaluation system; and
said data transfer unit comprising at least one USB standard unit located in said transmission path.

2. A magnetic resonance apparatus as claimed in claim 1 wherein said USB standard unit is formed as a USB 3.0 standard unit, or higher.

3. A magnetic resonance apparatus as claimed in claim 1 wherein said data transfer unit comprises at least 2 USB standard units.

4. A magnetic resonance apparatus as claimed in claim 1 wherein at least a portion of said USB standard unit is located outside of said region permeated by said basic magnetic field.

5. A magnetic resonance apparatus as claimed in claim 1 wherein said data transfer unit comprises at least one transducer unit that converts an electrical USB data transfer protocol into an optical data transfer protocol.

6. A magnetic resonance apparatus as claimed in claim 5 wherein said transducer unit is located outside of said region permeated by said basic magnetic field.

7. A magnetic resonance apparatus as claimed in claim 5 wherein said data transfer unit comprises at least one electromagnetic radiation-shielding unit located within said region permeated by said basic magnetic field, and wherein at least a portion of said transducer unit is located within said shielding unit so that said shielding unit shields said portion of said transducer unit from electromagnetic radiation.

8. A magnetic resonance apparatus as claimed in claim 1 wherein said data transfer unit comprises at least one transducer unit that converts an optical data transfer protocol into an electrical USB data transfer protocol.

9. A magnetic resonance apparatus as claimed in claim 8 wherein said transducer unit is located outside of said region permeated by said basic magnetic field.

10. A magnetic resonance apparatus as claimed in claim 8 wherein said data transfer unit comprises at least one electromagnetic radiation-shielding unit located within said region permeated by said basic magnetic field, and wherein at least a portion of said transducer unit is located within said shielding unit so that said shielding unit shields said portion of said transducer unit from electromagnetic radiation.

11. A magnetic resonance apparatus as claimed in claim 1 wherein said evaluation system comprises at least one mainboard with a processor unit mounted thereon, and wherein said USB standard unit is electrically coupled directly to said mainboard.

12. A magnetic resonance apparatus as claimed in claim 1 wherein said evaluation system comprises at least one PCI unit, and wherein said USB standard unit is electrically coupled to said PCI unit.

13. A method for transferring magnetic resonance signals comprising:
generating a main magnetic field that permeates a region;
with a measurement system located in said region permeated by said main magnetic field, exciting nuclear spins in, and detecting resulting magnetic resonance signals from, a subject located in said region permeated by said basic magnetic field;
in an evaluation system located outside of said region permeated by said basic magnetic field, evaluating said magnetic resonance signals; and
transferring data between said measurement system and said evaluation system along a data transfer path that comprises at least one USB standard unit.

14. A transfer method as claimed in claim 13 comprising:
in a transducer located in said data transfer path, converting an electrical USB data transfer protocol into an optical data transfer protocol.

15. A transfer method as claimed in claim 13 comprising, in a transducer located in said data transfer path, converting an optical data transfer protocol into an electrical USB data transfer protocol.
